(19) United States
(12) Patent Application Publication
(10) Pub. No.: US 2005/0182642 A1
(43) Pub. Date: Aug. 18, 2005

(54) Rules based case management system and method

(76) Inventor: Steven G. Pratt, San Diego, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 10/986,460

(22) Filed: Nov. 10, 2004

Related U.S. Application Data
(60) Provisional application No. 60/518,779, filed on Nov. 10, 2003.
(60) Provisional application No. 60/546,766, filed on Feb. 24, 2004.

(51) Int. Cl. G06F 17/60

(52) U.S. Cl. 705/1

(57) ABSTRACT

The invention described herein provides a process supporting the Internet enabled exchange of pertinent information about a legal matter between the liability holder, generally an insurance company, and the parties engaged in the mitigation of the liability, generally attorneys or associated service providers. Insurance company protocols are a series steps that must be adhered to, responded to, or that require some action or event. Protocols are part of the contractual arrangement between an individual or company processing a claim or case and the insurance company to which the claim or case has been made. They are currently paper-based and generally conveyed in a 3-ring binder. The invention described herein provides a software tool to generate unlimited insurance company claims or case management steps collectively referred to as the insurance company's proto col. The software will support protocols for most US-based insurance companies.

### FIELD OF THE INVENTION

This invention generally relates to computerized information management systems underpinned by a strong workflow component and more particularly to programmable computer systems utilizing the Internet to exchange information and using a hosting facility to store and retrieve information. It is employed as an application service provider and is not currently integrated into its customer's internal information systems. There are no components of this system that require more than a thin client or browser to access.

### BACKGROUND OF THE INVENTION

Large insurance companies and major corporations refer many of their cases to be litigated to outside law firms. The law firms are required to adhere to a set of stringent policies and rules, often called protocols, that cover every step associated with the case through litigation to closure. These steps, or protocols, are currently communicated via a paper-based mechanism. Compliance to these protocols is difficult for insurance companies to manage and difficult for law firms to ensure. Insurance company auditors travel periodically to their client law firms to review cases and issue notices of compliance and defect. Defects not resolved by the law firms often result in being terminated for future services by the insurance company.

An abstract of generic protocol steps along with the initiator generally associated with claims management include:

| Initiated By | Event Name |
|---|---|
| Adjuster | Status Report |
| Adjuster | Claims Notes |
| Adjuster | Reserve Review |
| Adjuster | Expense element |
| Adjuster | Follow-up notification, acknowledgement |
| | and response |
| Adjuster | Initial Receipt of File |
| Adjuster | Settlement Offer |
| Adjuster | Arbitration |
| Adjuster | Claim Closed |
| Adjuster | Claim Reopened |
| Adjuster | Log Notes |

An abstract of generic protocol steps along with the initiator generally associated with case management include:

| | |
|---|---|
| Attorney | Initial Receipt of File |
| Attorney | Status Report |
| Attorney | Demurrer |
| Attorney | Motion to Strike |
| Attorney | Deposition of Plaintiff |
| Attorney | Deposition of Witness |
| Attorney | Deposition of Expert |
| Attorney | Independent Medical Exam Request |
| Adjuster | Independent Medical Exam Authorization |
| Attorney | Discovery Responses |
| Attorney | Discovery Motion |
| Attorney | Dispositive Motions |
| Attorney | Settlement Offer |
| Adjuster | Settlement Offer Acceptance/Rejection |
| Attorney | CCP 998 Offer |
| Attorney | Expert Designation |
| Attorney | Trial Date |
| Attorney | Arbitration Date |
| Attorney | Mediation Date |
| Attorney | Pre-Trial Report |
| Attorney | Pre-Arbitration Report |
| Attorney | Pre-Mediation Report |
| Attorney | Generic Event |
| Attorney | Log Notes |
| Attorney | Reserve Review |
| Attorney | Follow Up |
| Attorney | Site Inspection |
| Attorney | Retention |
| Attorney | Expense |
| Attorney | Receipt of Release of Dismissal |

### OBJECTS OF THE INVENTION

To create a step (sometimes referred to in technical language as an event that:
Requires a response and or
Triggers an email and or
Allows attachments and or
Creates another step and or
Supports dependencies and or
Holds a cost amount and or
Is schedulable and or
Interacts with other steps and or
Links to any internet based digitized content via a standard URL

To use technology to communicate steps to all interested parties when key events are missed.

To provide a mechanism for symbolic interpretation that may be performed by humans or by a computer.

To establish a rules based platform that is both amenable to algorithmic processing and human consumption.

### BRIEF DESCRIPTION OF THE DIAGRAMS

The foregoing as well as other objects and features of the invention will be more readily apparent when considered in conjunction with the diagrams:

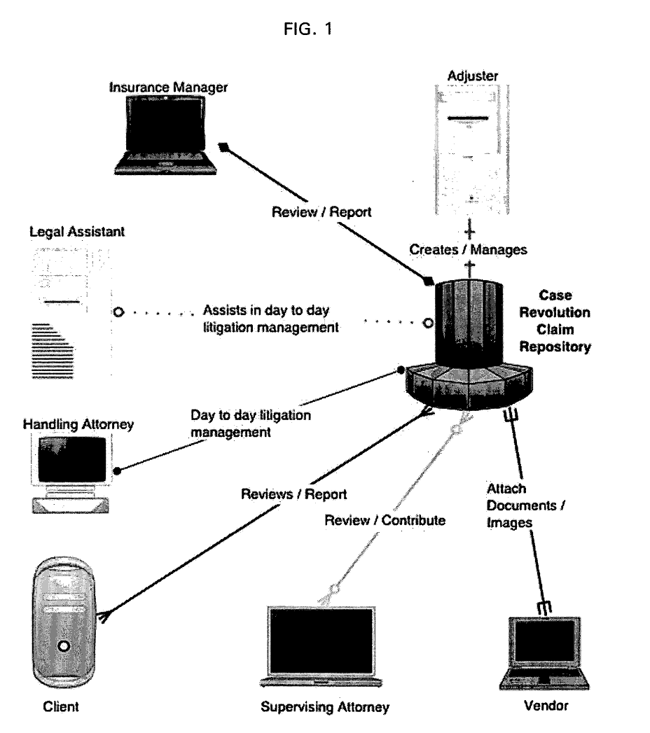

FIG. 1 is a diagram of interested parties that can be connected via the Internet to exchange information relevant to matters undergoing litigation.

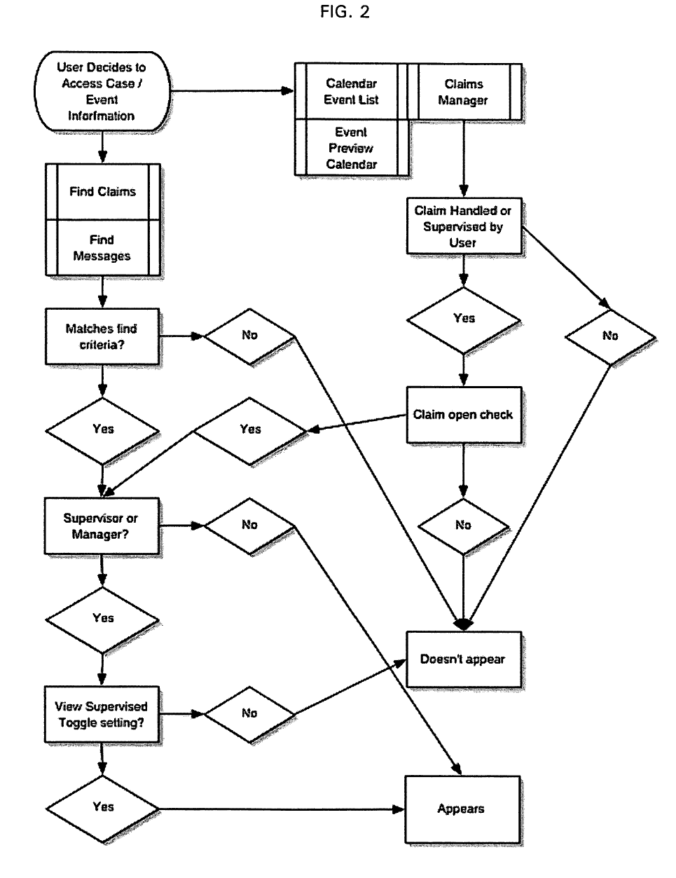

FIG. 2 Lifecycle of a system experience

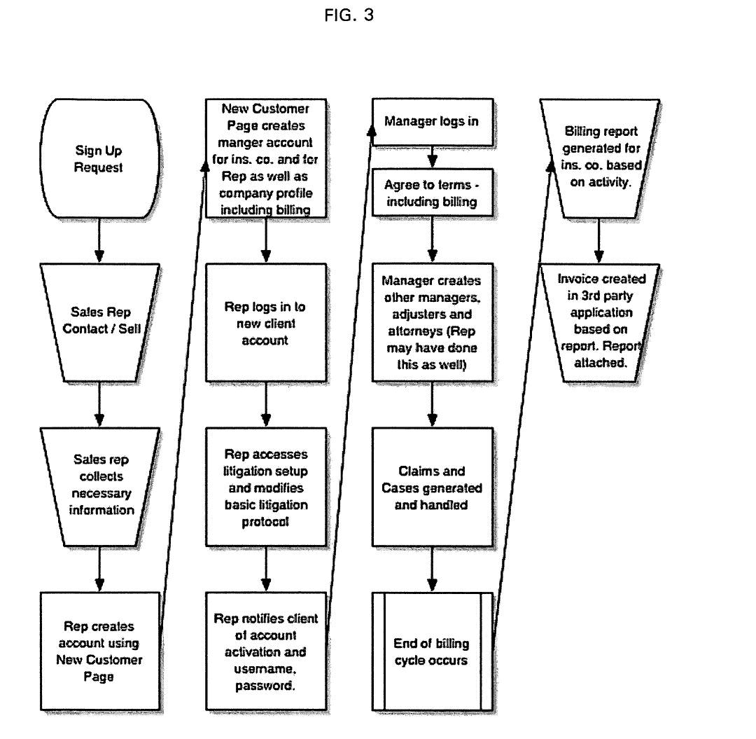

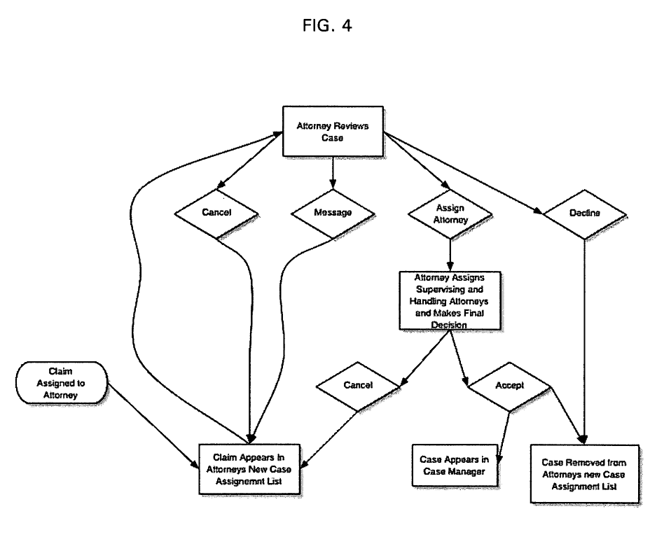

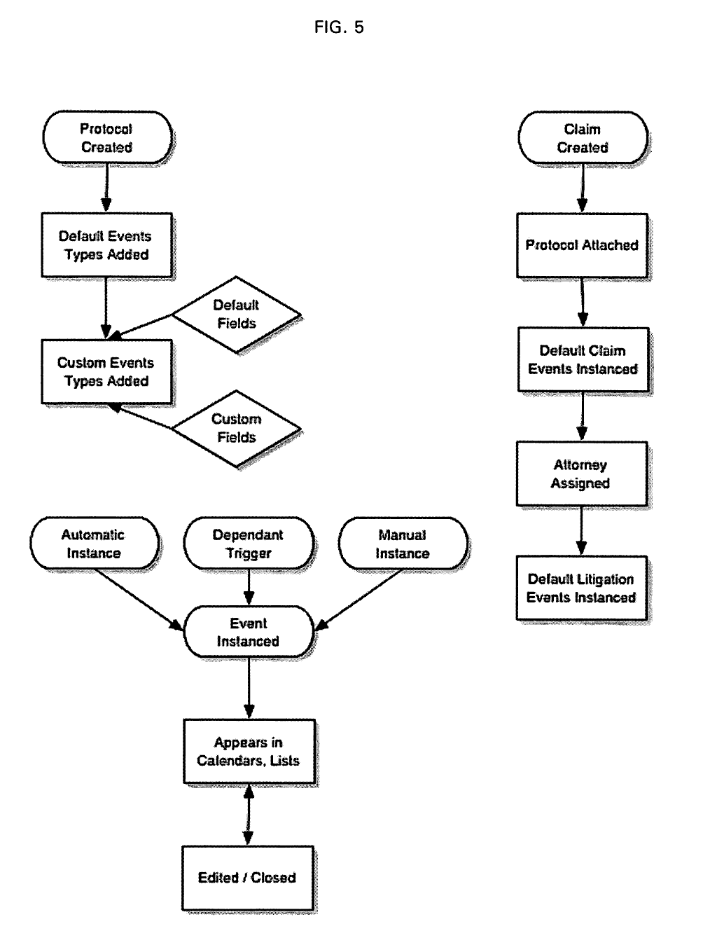

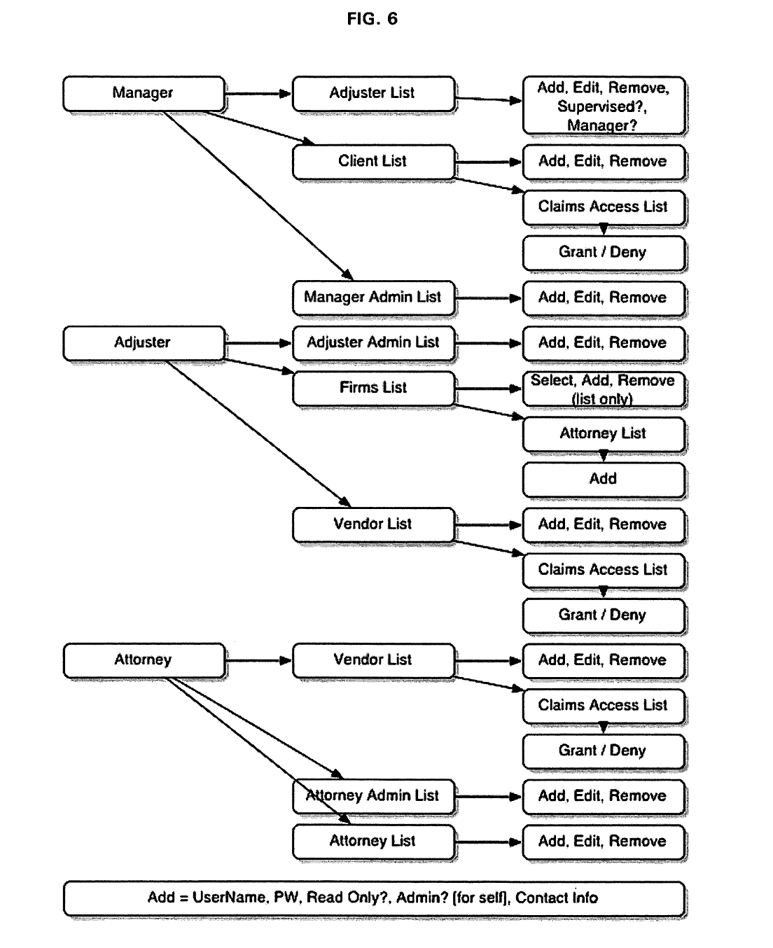

FIG. 3 Protocol Event flow

### DETAILED DESCRIPTION OF THE INVENTION

Referring now to FIG. 3, the subject invention is invoked at the system loading of a new insurance company customer to build all of their generic and unique protocol steps. It supports the definition of each step along the following rules:

1. A step is described in easily understood terms

2. A step may or may not be automatically started

3. A step may or may not be automatically submitted

4. A step may or may not be automatically authorized

5. A step may or may not carry a cost

6. A step carrying a cost may or may not have a default amount

7. A step carrying a cost may or may not require authorization above a threshold amount

8. An action may or may not be due within a predetermined number of days

9. This step may or may not occur again following an event or predetermined number of days

10. This step may or may not support attachments of digitized information or pictures

11. This step will be activated based on a predetermined controller such as the original claim opening, a review of the claim reserve or any XML step in the protocol

12. This step may launch step data stored in the system RDBMS as unformatted data or XML procedures with structured or unstructured data

13. Alerts may or may not be associated with this step

The invention relies on a technology architecture developed in the late 1990's called an application service provider.

The collective steps or protocol yield a workflow engine that is suitable for managing litigation matters arising from property and casualty claims, workers compensation claims, governmental claims, medical malpractice claims, and most other claims both foreign and domestic.

In this invention:
Existing insurance protocols are converted to steps such that they can be algorithmically monitored by a computer or visually reviewed by humans.
Automatic notifications based on time, events or actions serve as the communication mechanism between interested parties replacing paper and manual activity.
Missed commitments and deadlines are mitigated by advance warnings.
Facilitates a collection of information as input which may be in any digitized format.
Audience group targets are insurance managers, insurance adjusters, attorneys, vendors, clients and related parties. Each audience group has specific rights and responsibilities within the process custom tailored for their role.
The insurance company protocol will facilitate the overview of the performance of a particular law firm.

This invention is defined on:
An application services architecture
Resides in a Tier1 hosted service center
Multiple T-3 pipes to the Internet
99.99% ASP availability
dotNet technology

1. A rules based case management system, comprising:
a case revolution claim repository computer having a data storage device containing claim data;
at least one adjuster terminal and a means for accessing said claim data;
at least one client terminal and a means for accessing said claim data; and
at least one manager terminal in communication with said repository computer and said adjuster terminal, said terminal having a means for accessing and modifying said claim data.
